(19) United States
(12) Patent Application Publication
(10) Pub. No.: US 2012/0311248 A1
(43) Pub. Date: Dec. 6, 2012

(54) CACHE LINE LOCK FOR PROVIDING DYNAMIC SPARING

(75) Inventor: Benjiman L. Goodman, Cedar Park, TX (US)

(73) Assignee: INTERNATIONAL BUSINESS MACHINES CORPORATION, Armonk, NY (US)

(21) Appl. No.: 13/152,861

(22) Filed: Jun. 3, 2011

(51) Int. Cl. G06F 12/08; G06F 12/02

(52) U.S. Cl. 711/105; 711/118; 711/136; 711/E12.007; 711/E12.017

(57) ABSTRACT

A system that includes a memory, a cache, a purge mechanism, and a memory interface mechanism. The memory includes a failing memory element at a failing memory location. The cache is configured for storing corrected contents of the failing memory element in a locked state, with the corrected contents stored in a first cache line. The purge mechanism is configured for selecting and removing cache lines that are not in the locked state from the cache to make room for new cache allocations. The memory interface mechanism is configured for receiving a request to access the failing memory location, determining that corrected contents of the failing memory location are stored in first cache line in the cache, and accessing the first cache line in the cache.

### BACKGROUND

The present invention relates to a data processing system, and more specifically, to using cache to replace failing memory.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability computer systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the memory system design challenges, and include such items as ease of upgrade and reduced system environmental impact, such as space, power, and cooling.

Thus, computer system designs are intended to run for extremely long periods of time without failing or needing to be powered down to replace faulty components. However, over time, memory cells in DRAM chips or other memory subsystems can fail and potentially cause errors when accessed. These individual bad memory cells can result in large blocks of memory being taken out of the memory maps for the memory system. Further, the loss of the memory can lead to performance issues in the computer system and result in a computer system repair action to replace faulty components.

### SUMMARY

An embodiment is a system that includes a memory, a cache, a purge mechanism, and a memory interface mechanism. The memory includes a failing memory element at a failing memory location. The cache is configured for storing corrected contents of the failing memory element in a locked state, with the corrected contents stored in a first cache line. The purge mechanism is configured for selecting and removing cache lines that are not in the locked state from the cache to make room for new cache allocations. The memory interface mechanism is configured for: receiving a request to access the failing memory location, determining that corrected contents of the failing memory location are stored in first cache line in the cache, and accessing the first cache line in the cache.

Another embodiment is a method that includes identifying a failing memory element at a failing memory location in a memory in a computer system. The corrected contents of the failing memory element are stored in a locked state in a first line of a cache. A purge process that includes selecting and removing cache lines that are not in the locked state from the cache is performed. The data access requests are serviced. The servicing of data access requests includes receiving a request to access the failing memory location, determining that corrected contents of the failing memory location are stored in first cache line in the cache, and accessing the first cache line in the cache.

A further embodiment is a computer program product that includes a tangible storage medium readable by a processing circuit and storing instructions for execution by the processing circuit for performing a method. The method includes identifying a failing memory element at a failing memory location in a memory in a computer system. The corrected contents of the failing memory element are stored in a locked state in a first line of a cache. A purge process that includes selecting and removing cache lines that are not in the locked state from the cache is performed. The data access requests are serviced. The servicing of data access requests includes receiving a request to access the failing memory location, determining that corrected contents of the failing memory location are stored in first cache line in the cache, and accessing the first cache line in the cache.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a system for implementing cache line lock to provide dynamic sparing in accordance with an embodiment;

FIG. 2 is a block diagram of a system for implementing cache line lock to provide dynamic sparing in accordance with an embodiment;

FIG. 3 is a block diagram of a cache memory for implementing cache line lock to provide dynamic sparing in accordance with an embodiment;

FIG. 4 depicts a process flow for marking a cache line as locked in accordance with an embodiment; and

FIG. 5 depicts a process flow for preventing a cache line marked as locked from being removed from a cache in accordance with an embodiment.

### DETAILED DESCRIPTION

An embodiment uses cache memory to replace failed memory cells within a memory device. A new state, referred to herein as a “locked state”, is associated with cache entries that are currently being used to provide sparing capability to failing memory device cells. Cache entries having a state of locked are prevented from being removed from the cache memory during a cache memory purging process (also referred to as a victimization process), which is used whenever older cache entries are de-allocated from the cache to make room for new cache entry allocations to the cache. In an embodiment, a cache memory purging process uses a least-recently-used (LRU) algorithm to identify cache lines for removal from the cache to make room for new cache lines. Embodiments described herein will prevent the removal of a cache line identified for removal when the identified cache line has a state of locked.

A typical entry in a cache directory is made up of several elements (or fields) including an address of the cache line and a state of the cache line (e.g., valid, invalid). Embodiments utilize the existing state field in the cache directory entry to signify a new state of locked for a cache line. The state of locked signifies that the cache line is currently being used to replace a failing memory element. The embodiments described herein require do not require any specialized hardware, software or tracking registers, once the corrected data from the failing memory location has been stored in the cache and assigned a state of locked. An update is required in the purging logic to prevent cache lines with a state of locked from being removed from the cache during a purging process.

As used herein, the term “memory location” refers to any addressable unit in a memory device. For example, the addressable unit may be a cache line (or cache block) made up of 128 bytes. As used herein, the term “memory element” refers to one or more memory cells in a memory device. Typically the bits making up a memory location that contains one or more failing memory elements, are spared together as a unit in a cache line (or cache entry). In an embodiment, the size of a cache line is equal to (or corresponds to) the size of the memory location.

Embodiments described herein provide mechanisms for using cache in a memory system to replace failing memory cells within a memory device in the memory system. The memory system may be utilized with data processing devices such as servers, client data processing systems, stand-alone data processing systems, or any other type of data processing device. Moreover, the memory systems may be used in electronic devices in which memories are utilized including, but not limited to: printers, facsimile machines, storage devices, and flash drives.

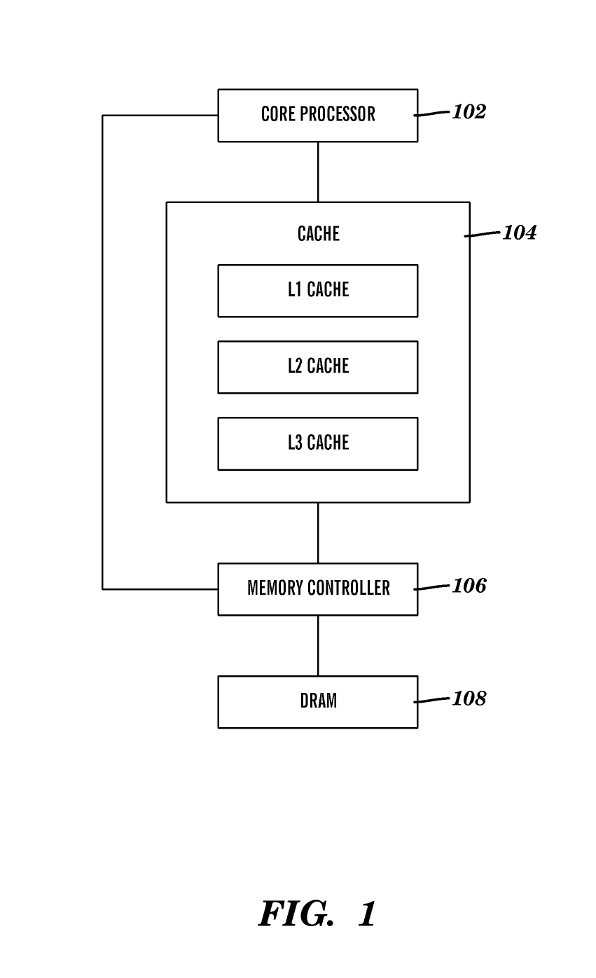

FIG. 1 is a block diagram of a system for implementing cache line lock to provide dynamic sparing in accordance with an embodiment. The system in FIG. 1 includes a memory controller 106 that is in communication with a cache memory 104, a dynamic random access memory (DRAM) 108 (e.g., a main memory), and a core processor 102. Though shown as a single block, the DRAM 108 may include a plurality of memory devices in one location or in a plurality of locations. The components shown in FIG. 1 can be located on the same integrated circuit or alternatively, they can be spread across any number of integrated circuits.

In an embodiment, the core processor 102 includes a memory interface that receives addresses of memory locations to be accessed and determines if memory contents associated with the address are stored in the cache memory 104. The cache memory 104 shown in FIG. 1 is an example of a cache subsystem with multiple cache hierarchies. In an embodiment, each level of the cache 104 (level one or “L1”, level two or “L2”, and level three or “L3”) includes its own directory with entries that include an address and current state for each cache line that is stored in the respective cache level (L1, L2, L3). In an embodiment, the current state is “valid” if the entry contains a valid address, “invalid” if the entry does not contain a valid address and may be overwritten by a new cache line, and “locked” if the entry is providing a spare location for a memory device. Typically, the core processor 102 looks for the address in the L1 cache first (the highest cache level in FIG. 1) followed by the L2 cache, and then looks in the L3 cache (the lowest cache level in FIG. 1) if the contents associated with the address are not located in the L1 or L2 cache.

If the address is not located in one of the cache memory directories, then the data is not located in the cache 104. The request from the core processor 102 is then forwarded from the cache controller to the memory controller 106 to access the data at the specified address on the DRAM 108. As shown in FIG. 1, the memory controller 106 communicates directly with the DRAM 108 to retrieve data at the requested address. In an embodiment, the memory controller 106 includes read and write buffers and sends row address strobe (RAS) and column address strobe (CAS) signals to the DRAM 108.

As described herein, both data that has been accessed (or is predicted to be accessed) and data that corresponds to a failing memory element (e.g., on the DRAM 108) are stored in the cache 104. Data that has been accessed and that does not correspond to a failing memory element may be removed from the cache 104 to make room for new data during a cache purge process. Data that corresponds to a failing memory element remains in the cache 104 and is not removed during the cache purge process. The cache directory keeps track of cache lines that are providing a spare location for failing memory elements by designating them with a state of locked. The cache that is providing a back up to a failing memory element may be located at any level in the cache hierarchy and in any physical location in the system.

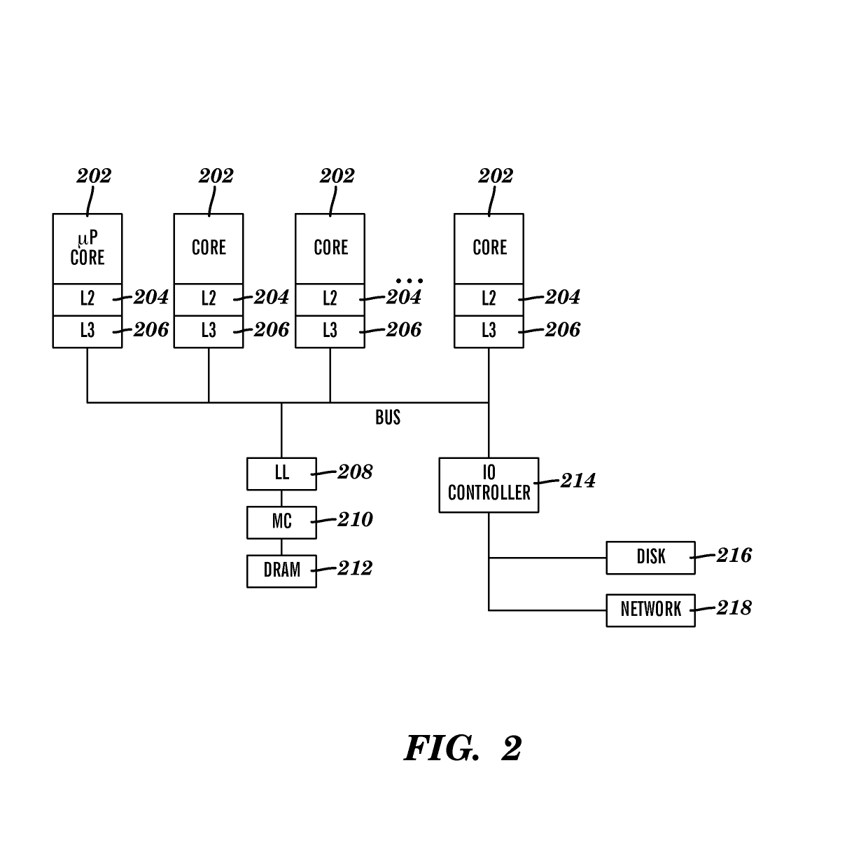

FIG. 2 is a block diagram of an exemplary multiple-processor (multi-processor) system for implementing cache line lock for dynamic sparing in accordance with an embodiment. The system in FIG. 2 includes several execution units or core processors 202, with each core processor 202 having its own dedicated high-level caches (L1 cache not shown, L2 cache 204, and L3 cache 206). Each core processor 202 is connected, via a bus to a lower level cache 208 and to an I/O controller 214. In the embodiment shown in FIG. 2, the I/O controller 214 is in communication with a disk drive 216 (e.g., a hard disk drive or “HDD”) and a network 218 to transmit and/or to receive data and commands. Also, a lower level (LL) cache 208 is connected to a memory controller 210. In an embodiment, the memory controller 210 detects an uncorrectable memory location in the DRAM 212 and initiates the use of a cache line in the LL cache 208 as a spare location for the uncorrectable memory location.

In an embodiment, operating systems are executed on the core processors 202 to coordinate and provide control of various components within the core processors 202 including memory accesses and I/Os. Each core processor 202 may operate as client or as a server. The system shown in FIG. 2 includes a plurality of core processors 202. In an alternative embodiment, a single core processor 202 is employed.

In an embodiment, instructions for an operating system, application and/or program are located on storage devices, such as disk drive 216, that are loaded into main memory (in the embodiment shown in FIG. 2, the main memory is implemented by DRAM 212) for execution by the core processor 202. The processes performed by the core processor 202 are performed using computer usable program code, which may be located in a memory such as, main memory (e.g., DRAM 212), LL cache 208, L2 cache 204 and/or L3 cache 206. In one embodiment, the instructions are loaded into the L2 cache 204 or the L3 cache 206 on a core processor 202 before being executed by the corresponding core processor 202.

A bus is shown in FIG. 2 to connect the core processors 202 to an I/O controller 214 and the LL cache 208. The bus may be comprised of a plurality of buses and may be implemented using any type of communication fabric or architecture that provides for a transfer of data between different components or devices attached to the fabric or architecture. In addition, FIG. 2 includes an input/output (I/O) controller 214 for transmitting data to and receiving data from, a disk drive 216 and a network 218.

The multi-processor system shown in FIG. 2 may take the form of any of a number of different data processing systems including client computing devices, server computing devices, a tablet computer, laptop computer, telephone or other communication device, a personal digital assistant (PDA), or the like. In some illustrative embodiments, the system shown in FIG. 2 is a portable computing device that is configured with flash memory to provide non-volatile memory for storing operating system files and/or user-generated data, for example. In other illustrative embodiments, the system shown in FIG. 2 is any type of digital commercial product that utilizes a memory system. For example, the system shown in FIG. 2 may be a printer, facsimile machine, flash memory device, wireless communication device, game system, portable video/music player, or any other type of consumer electronic device. Essentially, the system shown in FIG. 2 may be any known or later developed data processing system without architectural limitation.

In the embodiment of the multi-processor system shown in FIG. 2, a DRAM 212 is used for storing programs and data in main memory. The DRAM 212 provides temporary read/write storage while the hard disk 212 provides semi-permanent storage. The DRAM 212 is volatile, which means that it requires a steady flow of electricity to maintain its contents, and that as soon as the power is turned off, whatever data was in DRAM 212 is lost. The DRAM 212 is comprised of one or more memory elements made up of one or more memory cells, with each memory cell being made up from one transistor and one capacitor. Over time, memory cells in the DRAM 212 may fail and potentially cause errors when accessed. These individual bad memory cells may result in large blocks of memory being taken out of the memory maps for the memory system. The loss of all or a portion of main memory may lead to performance issues in the multi-processor system shown in FIG. 2 and result in a data processing system repair action to replace faulty components. In order to reduce performance issues within multi-processor systems and reduce repair actions due to memory system failures, the illustrative embodiments use cache to replace failed memory elements. When the memory controller 210 detects an error in data that is read from a memory device (e.g., DRAM 212), the memory controller 210 will correct the data using ECC techniques, e.g., and attempt to write the corrected data back to the DRAM 212 replacing the data that is in error in the DRAM 212. Then, the memory controller 210 re-reads the data from the DRAM 212 and checks the data for errors.

If the data is correct on the second read, then the error was a transient error and the memory controller 210 logs the read of the data as such. However, if the data is still incorrect on the second read, then the memory controller 210 logs the specific memory element(s) in the DRAM 212 as bad and indicates the DRAM 212 as needing to be repaired or replaced. The memory location containing the data that is still incorrect on the second read is referred to herein as an uncorrectable memory location. To repair the memory location containing the failing memory element(s), the memory controller 210 then issues a write operation to the cache, such as LL cache 208, with the address corresponding to the uncorrectable data for the faulty memory elements(s) in the DRAM 212.

In some instances, the DRAM ECC code cannot correct the 128B cache line data. In these cases, the program using this data must be shut down because the error is uncorrectable, but due to line locking the cache line address into the cache, the system can continue to use this physical address in the future, even though the DRAM 212 associated with this physical address is bad. In an embodiment, the MC 210 indicates to system firmware that the cache line address was uncorrectable and that the cache line address has been locked into the cache. The system firmware works with the hypervisor and the operating system to de-allocate the 4 KB page containing the 128B cache line address and shut down any process using that page. Once the page has been de-allocated from the page table entry (PTE), a new page can be created in the PTE using this page address because the 128B address is locked into the cache. A new PTE entry is created and the 4 KB page is paged in from disk to memory, where the 128B cache line address associated with the error is written to the cache because that address is locked into the cache, while the remaining cache lines of the page are written to DRAM 212 because those addresses are not locked in the cache.

Embodiments can limit the number of “ways” in a congruence class that can be locked. In one embodiment, the limit of the number of ways in a congruence class that can be locked is equal to the “number of ways−1” so that there is at least one way that is not locked.

Once the write of the corrected data to the cache is complete and the corrected data is identified as having a locked state, all read and/or write operations from the core processor 202 to the address of the failing memory location will use the data from the LL cache 208 instead of the data from the DRAM 212. This is because during normal processing, the core processor 202 looks first in the caches for data at a specified address, and only looks to the DRAM 212 or disk drive 216 if the data is not located in the cache. Because the corrected data has been stored in the cache with a state of locked it will always be found in the cache. Thus, in the embodiments described herein, once the state of line locked is applied to the corrected data, the corrected data is managed as typical cache data and does not require any additional hardware or software for tracking and/or accessing the corrected data.

The example memory device described herein is a DRAM 212, however, other types of memory may be utilized for main memory in accordance with an embodiment. For example, the main memory may be a static random access memory (SRAM) or a flash memory and/or it may be located on a memory module (e.g., a dual in-line memory module or “DIMM”) or other card structure. Further, as described herein, the DRAM 212 may actually be implemented by a plurality of memory devices.

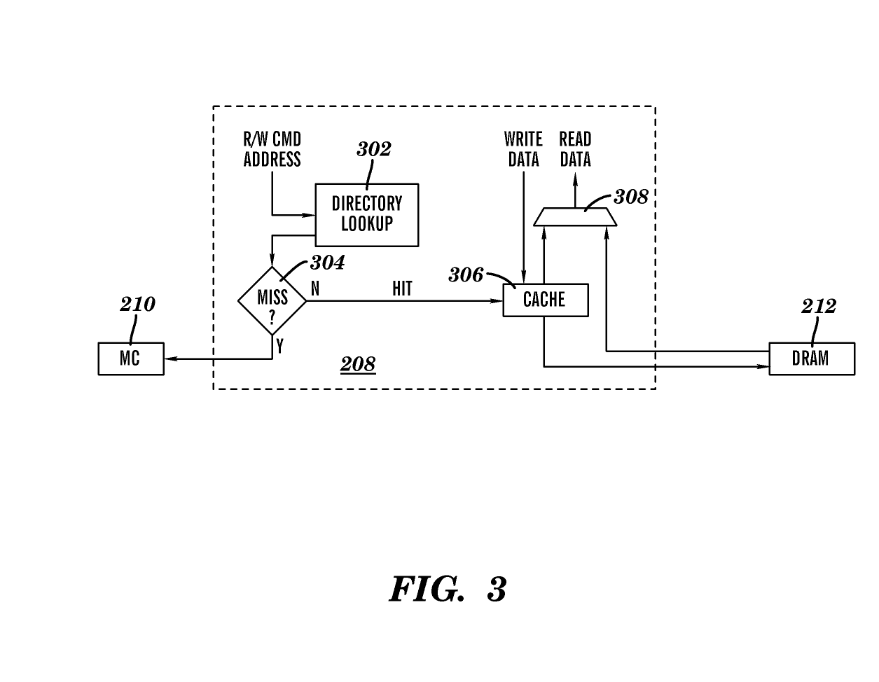

FIG. 3 is a block diagram of the LL cache 208 in accordance with an embodiment. The elements shown in the LL cache 208 may be implemented by any combination of logic (e.g., hardware, software and/or firmware). A read command and an address are received from a processor, such as core processor 202, at a directory 302 in the LL cache 208. If the address is not found in the directory 302, as determined by block 304, a miss occurs (the data is not in the cache) and a request is sent to the memory controller 210 to retrieve the data from the DRAM 212 (or other location). As shown in the embodiment in FIG. 3, the data that is retrieved from the DRAM 212 is input to a multiplexer 308 which selects the data returned from the DRAM 212 as the read data returned to the requestor when a cache miss has occurred. If the address is found in the directory, as determined by block 304, then a cache hit has occurred and the data is retrieved from the cache 306. As shown in the embodiment in FIG. 3, the data that is retrieved from the cache is input to the multiplexer 308 which selects the data returned from the cache 306 as the read data returned to the requestor when a cache hit has occurred.

In the embodiment shown in FIG. 3, when a write command and an address are received from a processor, the write data is written to the cache 306 and then to the DRAM 212. The write data may be written immediately to the DRAM 212 or it may be written to the DRAM as part of the cache purge process.

LL cache 208 is one example of a cache level that may be used by embodiments to provide sparing for memory devices (e.g., DRAM 212), as other cache levels may also be used to provide the sparing. In one embodiment, a portion of the cache is reserved for sparing, with the portion (e.g., size and/or location) being programmable at system start up and/or during system operation. In another embodiment, a maximum number of cache lines are available for sparing (and not restricted to specific locations) with the maximum number being programmable at system start up and/or during system operation.

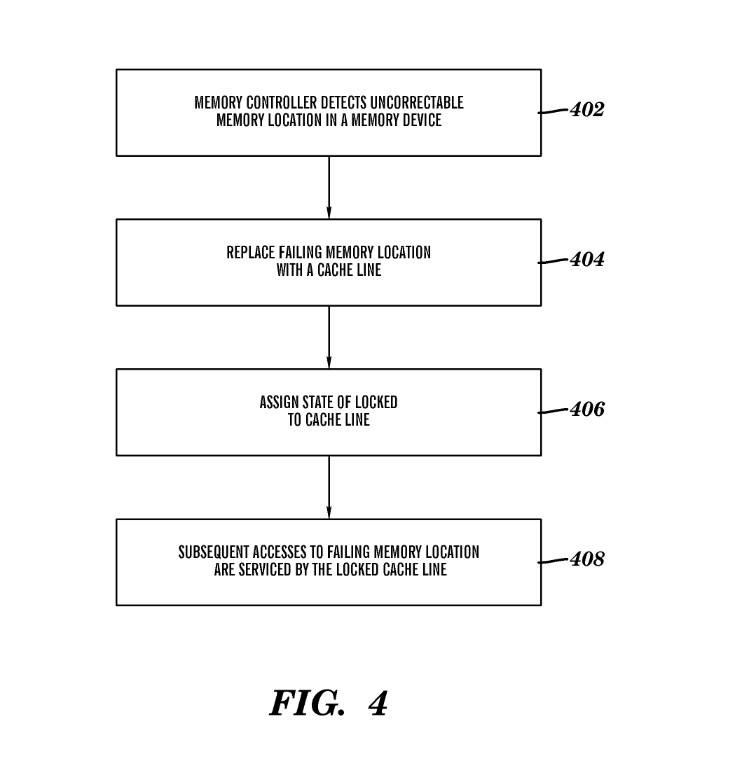

FIG. 4 depicts a process flow for replacing a failing memory location with a cache line and for assigning the cache line a state of locked in accordance with an embodiment. In an embodiment, the process flow depicted in FIG. 4 is performed by a combination of logic in a memory controller, such as memory controller 210, and logic in a cache, such as LL cache 208. At block 402, the memory controller detects an uncorrectable error at a memory location (e.g., one or more failing memory elements) in a memory device, such as DRAM 212. At block 404, the memory controller initiates repair of the failing location by replacing it with a cache line in the cache. In an embodiment, the repair is performed by the memory controller issuing a write operation to the cache with the corrected data for the faulty memory cell(s) in the memory device. Thus, a new entry corresponding to the new cache line is added to the cache directory with the address of the corrected data. At block 406, a state of locked is assigned to the new entry in the cache directory. At block 408, once the write of the corrected data to the cache is complete, all subsequent read and write operation requests from a requesting processor will be automatically sourced from the cache, thus bypassing the uncorrectable memory location. This is because during normal processing, the system will first look in the cache to source a data request, and because the new cache line has a state of locked it will remain in the cache and the uncorrectable memory location will not be accessed.

The embodiment described herein is address mapped cache, however embodiments also apply to content addressable cache.

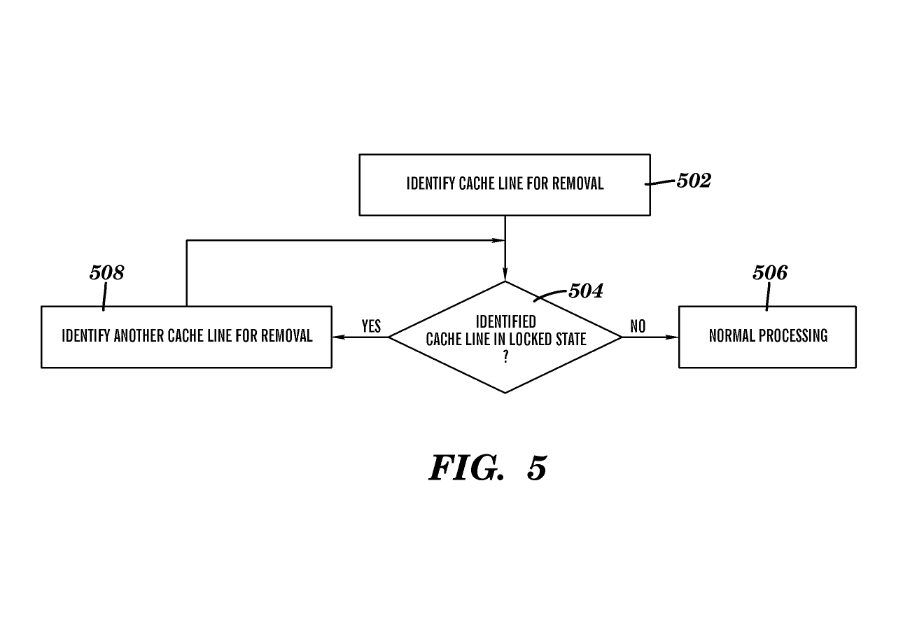

FIG. 5 depicts a process flow for preventing a cache line marked as line locked from being removed from a cache during a cache purge process in accordance with an embodiment. In an embodiment, the process flow depicted in FIG. 5 is performed by cache purge logic (also referred to herein as a “purge mechanism”) located in a cache, such as LL cache 208. The cache purge logic may be executed when the cache reaches a pre-defined (and programmable) capacity. Alternatively, the cache purge logic may be executed at pre-defined (and programmable) intervals, or scheduled in any other manner known in the art. In an embodiment, the cache purge logic implements a LRU algorithm. At block 502, a cache line has been identified as a candidate for removal by the cache purge logic. At block 502, a check is made (e.g., the state field in the directory entry is read) to determine if the identified cache line is in a locked state. If the state of the cache line is locked, then block 508 is performed and another cache line is identified for removal from the cache. Processing then continue at block 504. If the state of the cache line is not locked (e.g., the state is valid or invalid), as determined at block 504, then block 506 is performed and the purge process continues. In an embodiment, the cache line is deleted from the cache. In another embodiment, the state of the cache entry is changed to invalid signifying that it can be overwritten by new entries.

In an embodiment, the state of a cache line can be changed from locked to another state (e.g., valid, invalid) only by firmware and/or control programs that have authorization to change the state. This may be done when the cache line is no longer needed as a spare location because the memory device has been replaced or because the data at the address has been deleted.

Technical effects and benefits include the ability to reduce performance issues within a computer system and to reduce system downtime due to memory system/subsystem failures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system comprising:
a memory comprising a failing memory element at a failing memory location;
a cache configured for storing corrected contents of the failing memory element in a locked state, the corrected contents stored in a first cache line;
a purge mechanism configured for selecting and removing cache lines that are not in the locked state from the cache to make room for new cache allocations; and
a memory interface mechanism configured for:
receiving a request to access the failing memory location;
determining that corrected contents of the failing memory location are stored in first cache line in the cache; and
accessing the first cache line in the cache.

2. The system of claim 1, wherein the memory is a dynamic random access memory (DRAM).

3. The system of claim 1, wherein the selecting is responsive to a least recently used (LRU) algorithm.

4. The system of claim 1, wherein the removing comprises assigning an invalid state to the cache lines.

5. The system of claim 1, wherein once a cache line is in the locked state, the cache line remains in the locked state in the cache until it is updated by a control program that has authorization to remove the locked state from the cache line.

6. The system of claim 1, wherein the cache comprises multiple cache hierarchies and the first cache line is located in any of the multiple cache hierarchies.

7. The system of claim 1, wherein the system is a multiple processor system and a plurality of processors share the cache.

8. A method comprising:
identifying a failing memory element at a failing memory location in a memory in a computer system;
storing corrected contents of the failing memory element in a locked state in a first line of a cache;
performing a purge process that comprises selecting and removing cache lines that are not in the locked state from the cache; and
servicing data access requests, the servicing comprising:
receiving a request to access the failing memory location;
determining that corrected contents of the failing memory location are stored in first cache line in the cache; and
accessing the first cache line in the cache.

9. The method of claim 8, wherein the memory is a dynamic random access memory (DRAM).

10. The method of claim 8, wherein the selecting is responsive to a least recently used (LRU) algorithm.

11. The method of claim 8, wherein the removing comprises assigning an invalid state to the cache lines.

12. The method of claim 8, wherein once a cache line is in the locked state, the cache line remains in the locked state in the cache until it is updated by a control program that has authorization to remove the locked state from the cache line.

13. The method of claim 8, wherein the cache comprises multiple cache hierarchies and the first cache line is located in any of the multiple cache hierarchies.

14. The method of claim 8, wherein the computer system is a multiple processor system and a plurality of processors share the cache.

15. A computer program product comprising:
a tangible storage medium readable by a processing circuit and storing instructions for execution by the processing circuit for performing a method comprising:
identifying a failing memory element at a failing memory location in a memory in a computer system;
storing corrected contents of the failing memory element in a locked state in a first line of a cache;
performing a purge process that comprises selecting and removing cache lines that are not in the locked state from the cache; and
servicing data access requests, the servicing comprising:
receiving a request to access the failing memory location;
determining that corrected contents of the failing memory location are stored in first cache line in the cache; and
accessing the first cache line in the cache.

16. The computer program product of claim 15, wherein the memory is a dynamic random access memory (DRAM).

17. The computer program product of claim 15, wherein the selecting is responsive to a least recently used (LRU) algorithm.

18. The computer program product of claim 15, wherein the removing comprises assigning an invalid state to the cache lines.

19. The computer program product of claim 15, wherein once a cache line is in the locked state, the cache line remains in the locked state in the cache until it is updated by a control program that has authorization to remove the locked state from the cache line.

20. The computer program product of claim 15, wherein the cache comprises multiple cache hierarchies and the first cache line is located in any of the multiple cache hierarchies.
